(19) United States
(12) Patent Application Publication
(10) Pub. No.: US 2026/0005327 A1
(43) Pub. Date: Jan. 1, 2026

(54) GRAPHENE BATTERY

(71) Applicant: MINTSOFT, LLC, Newport Beach, CA (US)

(72) Inventor: Jason Mindte, Newport Beach, CA (US)

(21) Appl. No.: 18/867,594

(22) PCT Filed: May 18, 2023
(86) PCT No.: PCT/US2023/022724

§ 371 Date: Nov. 20, 2024

Related U.S. Application Data
(60) Provisional application No. 63/344,319, filed on May 20, 2022.

(51) Int. Cl. H01M 10/42; H01G 11/52; H01G 11/68

(52) U.S. Cl. CPC H01M 10/4264; H01G 11/52; H01G 11/68; H01M 2010/4271

(57) ABSTRACT

A power management system employing a graphene battery pack is described. The graphene battery may include a positive terminal and a negative terminal, and one or more supercapacitors each connected to the terminals. In some embodiments, each of the supercapacitors may include current collectors/metal plates having a first graphene coating and a second graphene coating. In various embodiments, the power management system may include a computer system used to interface to an electricity grid associated with a premises and to a graphene battery. In some embodiments, the power management system can be configured to provide power to appliances within the premises under a first operation mode, which specifies the electricity grid as a sole power source for the appliances, or provide power to the appliances under a second operation mode, wherein specifies the graphene battery as the sole power source or a partial power source for the appliances.

### CROSS-REFERENCE TO RELATED APPLICATION

This application claims priority and the benefit of U.S. Provisional Patent Application No. 63/344,319, filed on May 20, 2022, the contents of which are hereby incorporated by reference in their entirety.

### BACKGROUND

The average home in California uses around half as much energy as the average American household. However, California households pay the highest rates in the entire country. In fact, Californian's pay around $1,700 per household/per year for electricity, and rates continue to rise. This is due to the state's many renewable-energy mandates and transmission-system upgrades.

Although other factors can increase electricity usage, air conditioning represents a large expense for most homeowners. This is especially true for those living in warmer areas where electricity rates are high. During peak months and times, air conditioning alone can cost homeowners hundreds of dollars each month. It's not just homeowners that suffer with higher costs during summer. Businesses spend a considerable amount of money on energy bills during the hottest times of the year. For example, Americans spend more than $22 billion a year on electricity to cool their homes with air conditioning.

According to the US Department of Energy, consumers use a whopping 183 billion kilowatt-hours to cool their homes. This accounts for 15% of all energy used in most homes and can represent up to 70% of a summer electricity bill for residents living in warmer climates.

Power outages also present a serious problem for businesses of all shapes and sizes. Businesses, regardless of their size, require power every day to run their operations. When the power goes out, downtime occurs, costing businesses thousands, if not millions, of dollars. Long-lasting outages can cause irreversible damage. It's crucial that leaders create a plan to prevent power outages from negatively impacting their business.

For consumers, power outages represent a major problem. When a natural disaster such as an Artic blast overwhelms a power grid, thousands of residents that relies on power for their ventilators, heating systems, and other medically-necessary devices may find themselves fighting to stay comfortable and alive as temperatures dropped dangerously low. During this time, even gas generators couldn't keep up. Residents around the state waited days for their power to return.

It's predicted that these weather events will happen more frequently in the coming years. This, combined with an aging power grid, means real trouble for homeowners and businesses around the country. It's never been more important to have a back-up plan for power. Mint Controls brings that option to the table.

Despite growing storage demands, many warehouses around the U.S. sit relatively empty. In fact, most warehouses only use around 20% of their available space. As American businesses compete to bring new products to market faster, and at a much higher volume, the need for available storage space skyrockets, putting warehouses and third-party logistics (3PL) companies in a position of power. Unfortunately, without a way to advertise their storage capabilities, these warehouses often do not attract repeat customers, leaving the potential for significant revenues untapped.

### BRIEF DESCRIPTION OF THE FIGURES

FIG. 1 illustrates an example composition of the Mint Controls' graphene battery according to various embodiments of the disclosure;

FIG. 2 is a perspective view of a graphene battery pack according to various embodiments of the disclosure;

FIG. 3 is a cross-sectional view of the graphene battery pack of FIG. 2;

FIG. 4 is another cross-sectional view of the graphene battery pack of FIG. 2;

FIGS. 5A and 5B show two other perspective views of the graphene battery pack of FIG. 2;

FIG. 6A illustrates an example graphene battery module according to various embodiments of the disclosure;

FIG. 6B illustrates an example supercapacitor according to various embodiments of the disclosure;

FIG. 6C illustrates a cross-sectional view of an example supercapacitor according to various embodiments of the disclosure;

FIG. 6D is a perspective view of an example supercapacitor according to various embodiments of the disclosure;

FIG. 6E is a perspective view of an enclosure of the graphene battery module shown in FIG. 6A;

FIG. 6F illustrates multiple supercapacitors disposed within an enclosure of a graphene battery module according to various embodiments of the disclosure;

FIG. 6G illustrates example terminals of a graphene battery module installed on the top side of the graphene battery module according to various embodiments of the disclosure;

FIG. 6H illustrates an example supercapacitor that can be installed within a graphene battery module according to various embodiments of the disclosure;

FIGS. 6I and 6J illustrate a charging model and a discharging model, respectively, for a supercapacitor according to various embodiments of the disclosure;

FIG. 7 illustrates an example power management system that can be used to implement a battery pack to a power/electricity grid for supplying electricity according to an embodiment of the present disclosure; and

FIG. 8 is a block diagram of a computer system according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

As energy needs increase, consumers and businesses look for ways to reduce their energy costs and improve reliability. While alternative options exist, these options depend on factors outside the general public's control. In order to make power sources like wind and solar a viable option for consumers, the energy must be collected and properly stored with minimal loss of energy.

The graphene batteries, constructed using the techniques disclosed herein, provides a superior energy solution for businesses and residential environments. Graphene provides a flexible and customizable option. The graphene batteries can be custom-tailored for a variety of situations. This document discusses various applications of graphene batteries for residential and commercial applications.

The graphene batteries, as disclosed herein, can be installed directly on an air conditioning unit or other major appliances. The battery may be charged at night or through solar power, and may provide adequate electricity to the unit. This solution reduces or eliminates electricity costs and creates a powerwall for the home or business.

A powerwall is an integrated battery back-up. It provides power to the home or business in the event of a power outage. The system collects and stores energy from solar or other sources for access when and where it is needed most.

An increasing number of consumers have already started installing backup power supplies in their homes and businesses. These systems are either grid-tied or fully independent. They draw power directly from the grid or from solar panels installed on the home or business.

The graphene battery solution, as disclosed herein, takes the powerwall system one step further by using Graphene. The leading competitor uses lithium-ion or a lithium nickel manganese cobalt oxide (NMC) battery. Graphene can hold up to 1,000 Watt-hour (Wh) per kilogram while Lithium-ion can only store up to 180 Wh per kilogram. Graphene is also safer than other options. Lithium-ion is prone to overheating, overcharging, and puncture-all of which can cause disastrous results for the home or business where installed. Graphene is more stable, flexible, stronger, and more resilient to potential issues.

### Energy Storage

Energy storage allows homeowners and businesses to save money while ensuring continuous power, even during rolling blackouts and outages. Energy storage reduces the cost to provide frequency regulation and spinning reserve services. Energy storage offsets the cost to consumers by allowing them to store low-cost energy for use during peak periods when electricity rates are high.

During power outages, the right energy storage solution allows businesses to avoid costly disruptions and continue business as normal. Homeowners and renters can prevent spoiled food and medicines and keep important appliances and devices running, even during extended outages. This helps consumers prevent temperature-related illness while avoiding the inconvenience of rolling blackouts and outages caused by other factors.

The same concept that applies to backup power for personal devices can be scaled to provide power to an entire building or even the entire grid.

Energy storage smooths out the delivery of variable or intermittent resources by storing excess energy at peak times and delivering it when conditions are not favorable for energy collection. Energy storage supports the efficient delivery of electricity for inflexible baseload resources. When demand changes rapidly and increased flexibility is required, energy storage can be used to inject or extract electricity as needed to match load. For example, a computer system that connects the graphene battery of a premises and the electricity grid may monitor load corresponding to the electricity grid. When an anomaly is detected (e.g., a power outage, energy demand exceeds a threshold for the electricity grid), the computer system may trigger a switch to provide electricity to appliances of the house using energy from the graphene battery. In some embodiments, the computer system may completely switch the power source over to the graphene battery such that the graphene battery becomes the sole power source for the appliances of the premises. In some embodiments, the computer system may use the power from the graphene battery to supplement the power from the electricity grid. The transition may be seamless such that it does not cause any interruptions to the usage of the appliances for the user.

Energy storage allows electricity to be stored for when and where it is needed most. The right energy storage solution reduces greenhouse gas emissions and introduces more efficiency and flexibility to the grid. As cleaner energy gets introduced to the existing energy supply, American reliance on pollution-emitting peak power plants and other threats to the environment decreases.

By using the graphene solution disclosed herein, consumers and businesses can ensure proper and safe storage of energy. The specially-designed graphene battery charges and releases electricity in very little time, allowing for multiple cycles throughout the day.

The graphene battery provides safe and reliable power for up to one million cycles and at least fifty years. Adding solar increases battery potential, protecting against power outages for even longer periods of time.

The graphene solution, as disclosed herein, can be used in multiple scenarios and situations. Homeowners and businesses can use the solution to reduce energy costs and ensure continuous power. When used to power home appliances, the graphene solution ensures cost-efficient cooling while effectively creating a powerwall protection for the home.

### Graphene

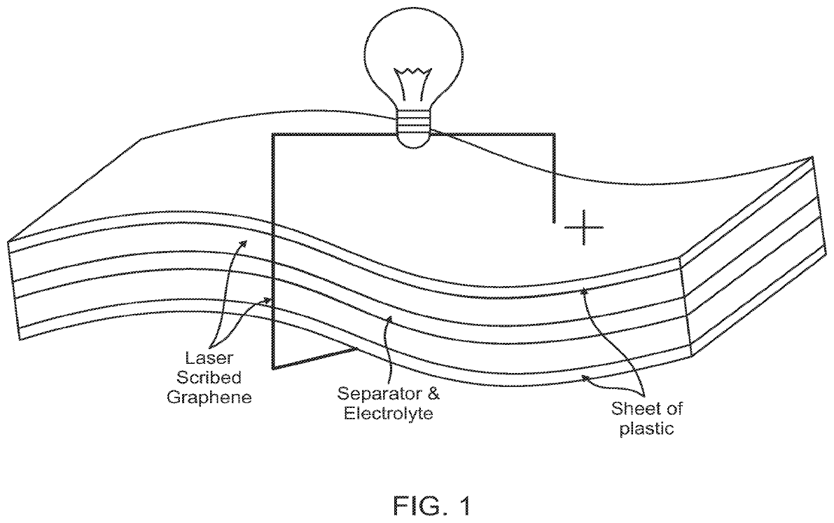

Graphene is a single layer of carbon atoms, tightly bound in a hexagonal honeycomb lattice. At just 1 atom thick, graphene is the thinnest and strongest compound known to man. In fact, graphene is 100-300 times stronger than steel. In addition to this compound's excellent strength, it is also the best conductor of heat at room temperature and, most importantly, electricity. FIG. 1 illustrates an example composition of the Mint Controls' graphene battery according to various embodiments of the disclosure.

Graphene's electron mobility in one hundred times faster than silicon. Graphene conducts heat two times better than diamond. Its electrical conductivity is thirteen times better than copper. Because graphene absorbs only 2.3% of reflected light, it is impervious. Even helium (the smallest atom) cannot pass through a monolayer graphene sheet.

Graphene is currently the most studied material on Earth. Mint Controls has performed extensive testing and research on the Company's Graphene Battery and Graphene Solutions. Testing has revealed the viability of the Graphene Solution as a safe and effective energy storage solution for homes and businesses.

### Graphene Battery Packs for Electrical Vehicles

Known for its exceptional flexibility, electrical conductivity, and mechanical strength, graphene allows for quick charging, increased capacity, improved performance, and extended battery life span. Graphene has an ultimate tensile strength of 130,000,000,000 Pascals. Unlike lithium-ion, lead acid, and other types of batteries, graphene does not lose its ability to charge over time. Since graphene is composed entirely of carbon, the Graphene Battery is 95% biodegradable, making graphene an environmental-friendly option.

In some embodiments, the graphene battery packs as disclosed herein may be used as a power source for golf carts, utility carts, & turf utility vehicles. Due to its characteristics, graphene provides a superior alternative to other types of batteries.

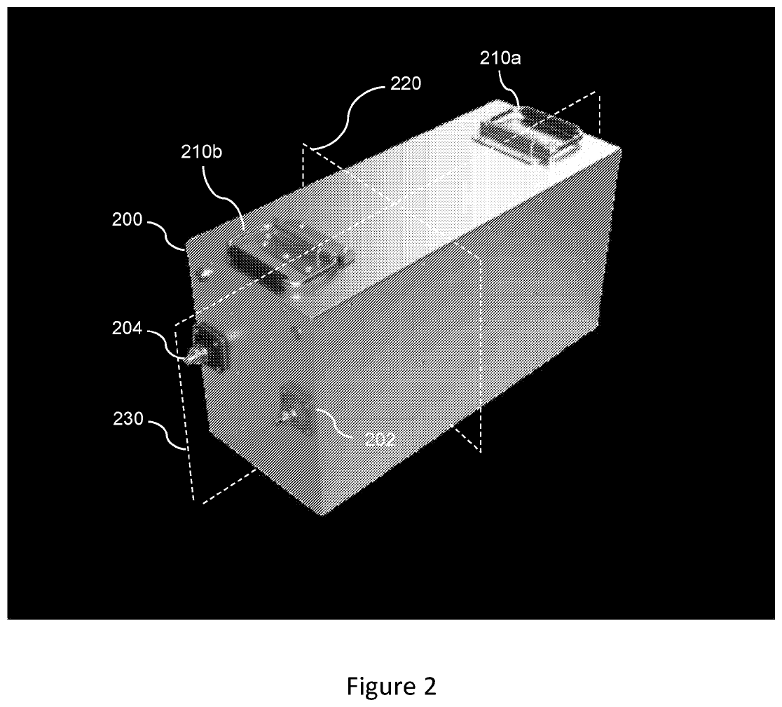

FIG. 2 is a perspective view of a graphene battery pack 200 according to various embodiments of the disclosure. As shown, the graphene battery pack 200 has a metal casing. The casing can be made using materials such as aluminum, steel, titanium, etc. The graphene battery pack 200 has two terminals—a positive terminal 202 and a negative terminal 204. The graphene battery pack 200 may also include one or more handles (e.g., handles 210a and 210b) to enable easy transportation of the graphene battery pack 200.

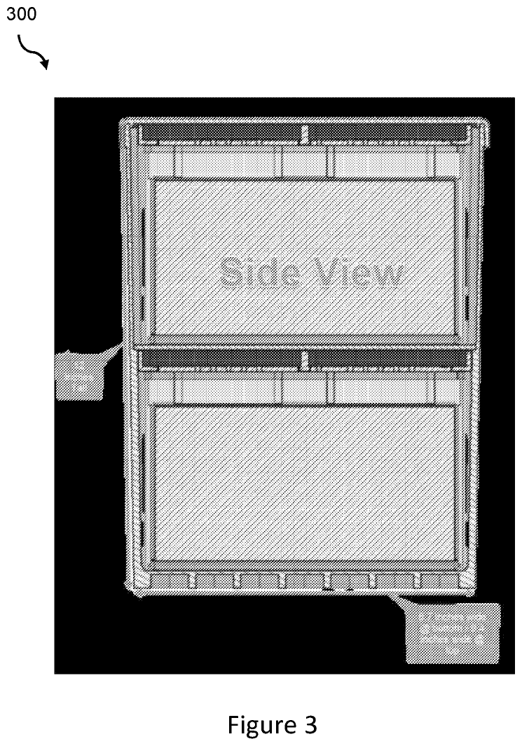

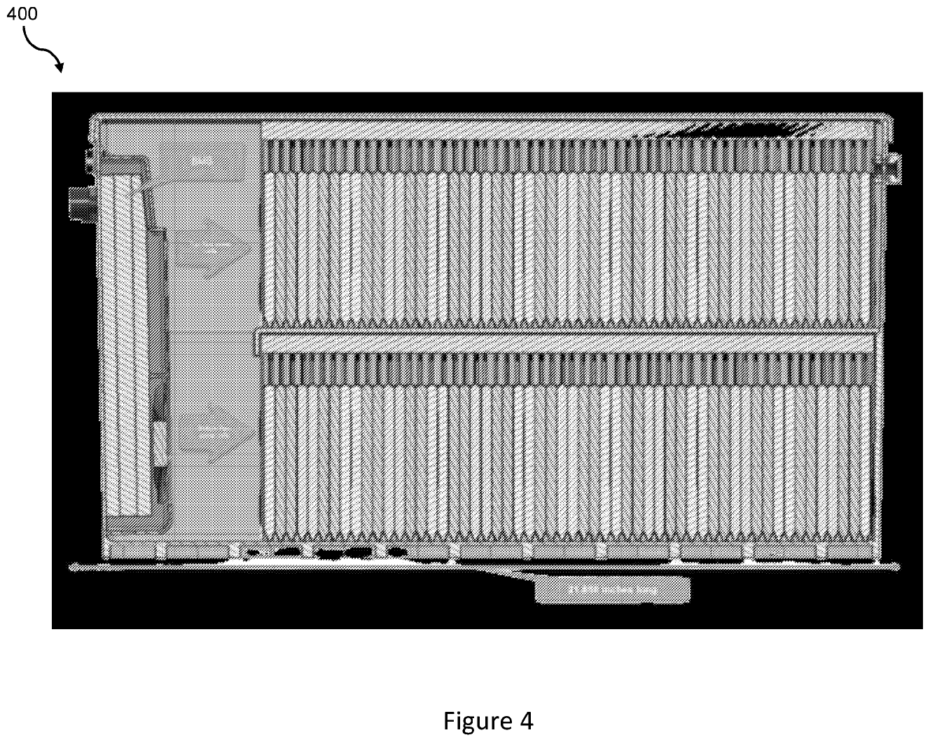

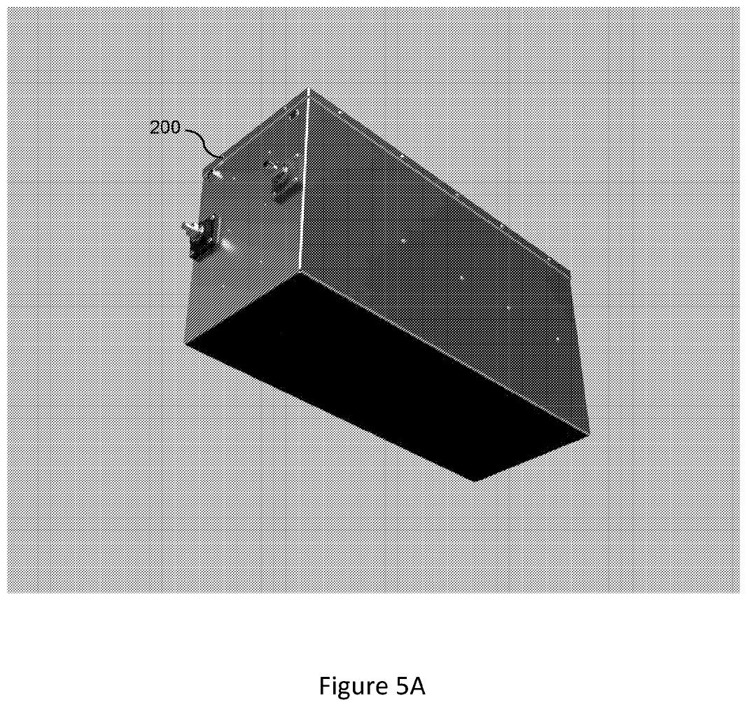

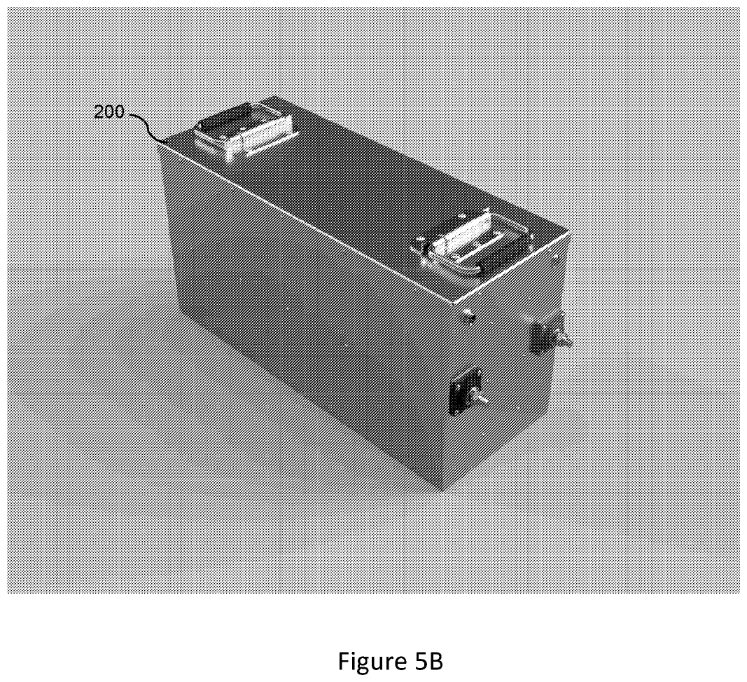

FIG. 3 is a cross-sectional view 300 of the graphene battery pack 200 based on a cross-sectional plane 220. FIG. 4 is another cross-sectional view 400 of the graphene battery pack 200 based on a cross-sectional plane 230. FIGS. 5A and 5B show two other perspective views of the graphene battery pack 200.

Below are some of the characteristics of the graphene battery packs constructed using the techniques disclosed herein:
Unlimited Charges
Durable Metal Casing
Charges in Less Time Than Other Solutions
100% Capacity Possible
Environmentally Responsible-95% Recyclable
Long Life Span-Outlives Most Vehicles
Solid State Battery-No Liquid
Lower Cost Than Other Solutions
Can Be Used in Freezing Temperatures
Lower Fire Risk.
Does Not Produce Toxic Fumes While Charging

The table below is the Specification for an example graphene battery pack:

| Dimensions | 21.877 × 9.481 × 12.063″ | | Operating Temperature Range | ′−4 to 140° | F. |
|---|---|---|---|---|---|
| Rack Space Units | 3.43 | | Storage Temperature Range | ′−4 to 131° | F. |
| Rack Space Height | 6″ | | Protection Class | IP20 | |
| Series Capacitors | 14 | | Inner Cell Pack Layout - Columns (2) | | |
| Parallel Capacitors | 4 | | Total Cells Capacitance | 2,352,000 | f |
| Battery Banks in Parallel | 2 | | Total Capacitance | 6,000 | f |
| Rated Voltage | 51.80 | V | Estimated VA Hours | 8,400 | VAh |
| Max Surge Voltage | 59.50 | V | Nominal Energy Rating | 8.40 | kVAh |
| Max Continuous Voltage | 58.80 | V | Max Continuous Voltage | 54.60 | V |
| Min Voltage | 42 | V | Min Voltage | 49.40 | V |
| Nominal Current | 80 | A | Nominal Current A | 1,760.00 | ADC |
| Continuous Current | 160 | A | Continuous Current A | 3,520.00 | ADC |
| Peak current (5 Sec) | 240.00 | A | Peak Current A | 5,280.00 | ADC |
| Maximum Charging Current | 225 | A | Capacitance in Farads | 24,024,000.00 | f |
| Full to Empty Discharge Time at Maximum | 60.81 | Minutes | Total Capacitors | 1,144 | |
| Empty to Full Charge Time at Maximum | 43.24 | Minutes | Run Time (100% Load) | 9.9 | Hours |
| Maximum Inter-Cell Balance Discharge Current | 200 | mA | VA Hours | 85,800.00 | VA |
| Overcharge Protection Cutoff Voltage Per Cell | 4.25 | V | Nominal Energy Rating | 85.80 | kVAh |
| Overcharge Protection Release Voltage Per Cell | 4.187 | V | Assumed Power Factor | 1.00 | |
| Over Discharge Protection Cutoff Voltage Per Cell | 3.8 | V | Energy Storage (Watt Hours) | 8,400 | Wh |

| | | | | |
|---|---|---|---|---|
| Over Discharge Protection Release Voltage PerCell | 3.9 | V | Energy Storage (Amp Hours) Self-Usage | 126.16 Ah 2 VA |

| | | | | |
|---|---|---|---|---|
| Low Temperature Cutoff Temp | 5 (115) ° F. (° C.) | Power Consumption Internal Resistance | ≤5.25 | mΩ |
| Low Temperature Release Temp | 9 (−13) ° F. (° C.) | Leakage Current | ≤31.111 | mΩ |

| | | | |
|---|---|---|---|
| High Temperature Cutoff Temp | 131 (55) ° F. (° C.) | Cycle Life | 43,000 |
| High Temperature Release Temp | 127 (53) ° F. (° C.) | | |

### Fully Enclosed Graphene Battery Modules

Using the techniques disclosed herein, a fully-enclosed standalone graphene battery modules can be constructed and made available for use in a much variety of applications, such as electric vehicles or vessels (e.g., cars, trains, buses, forklifts, golf carts, boats, etc.), farm equipment, energy storage (e.g., powerwalls in residence or commercial buildings, etc.), data centers, and others. Through extensive testing and research, Applicant has developed high quality products designed to combat a wide range of energy concerns. The graphene battery modules as disclosed herein provide consistent, reliable results, even when used repeatedly for years. These graphene battery modules can undergo thousands of charge/discharge cycles with absolutely no loss of power or efficiency. The usage of graphene as the materials to construct the battery modules ensures durability, long lifespan, lower cost over-time, fewer maintenance requirements, and reduced risk of fire over lithium-ion.

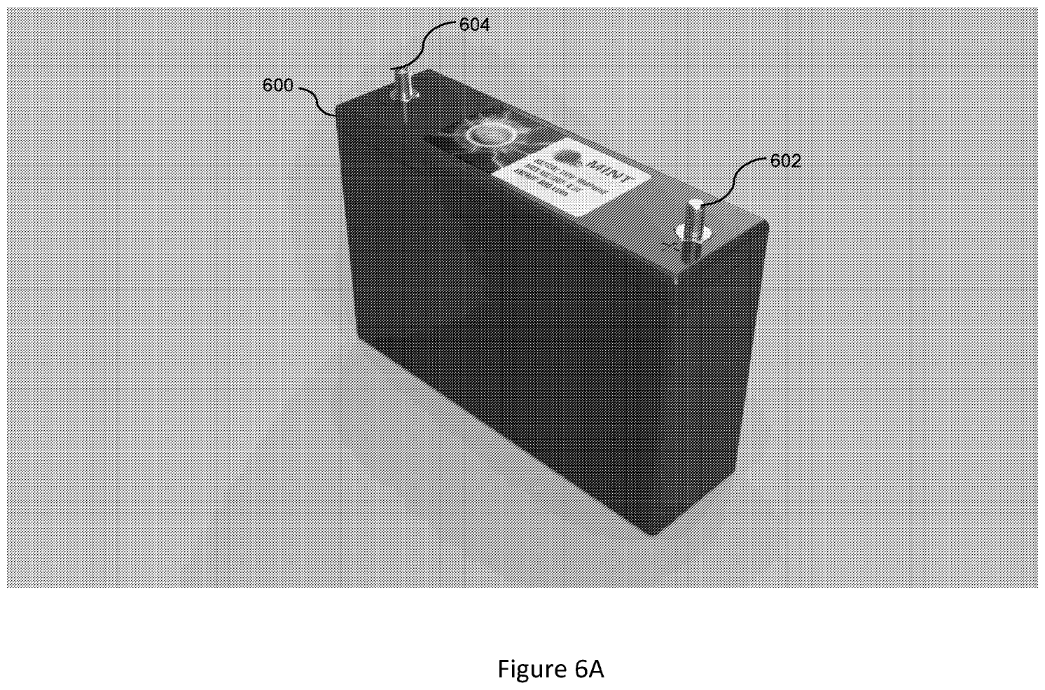

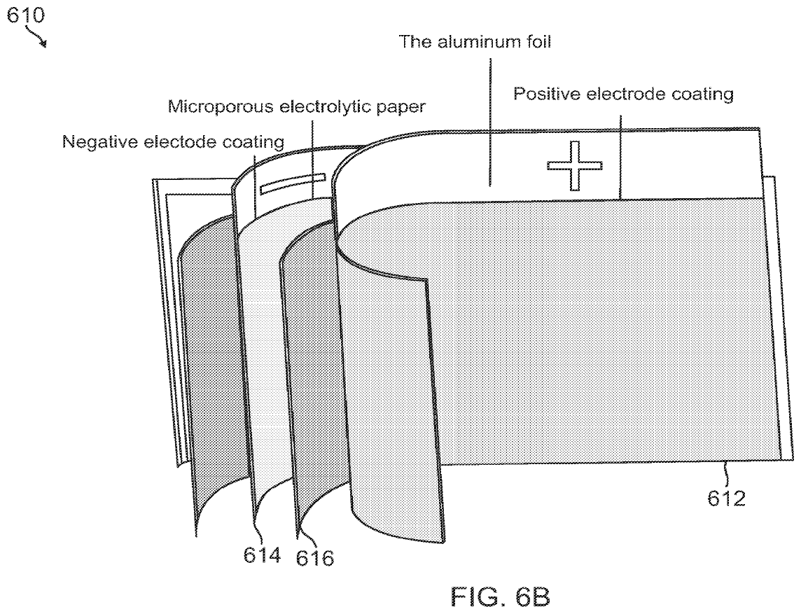

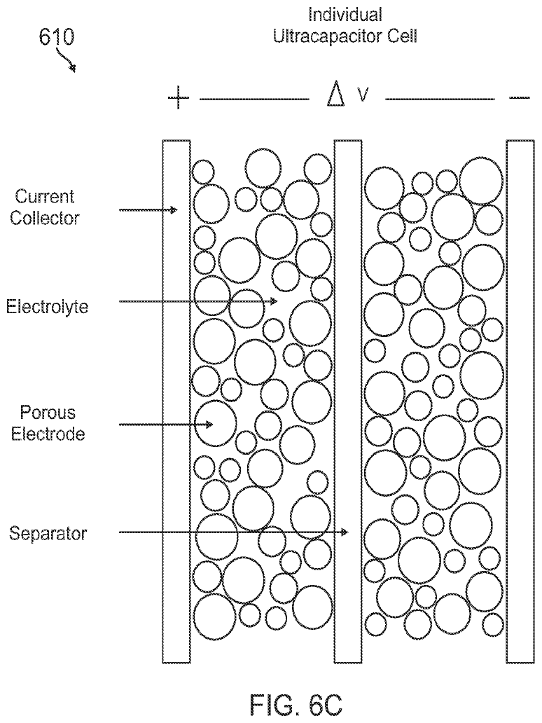

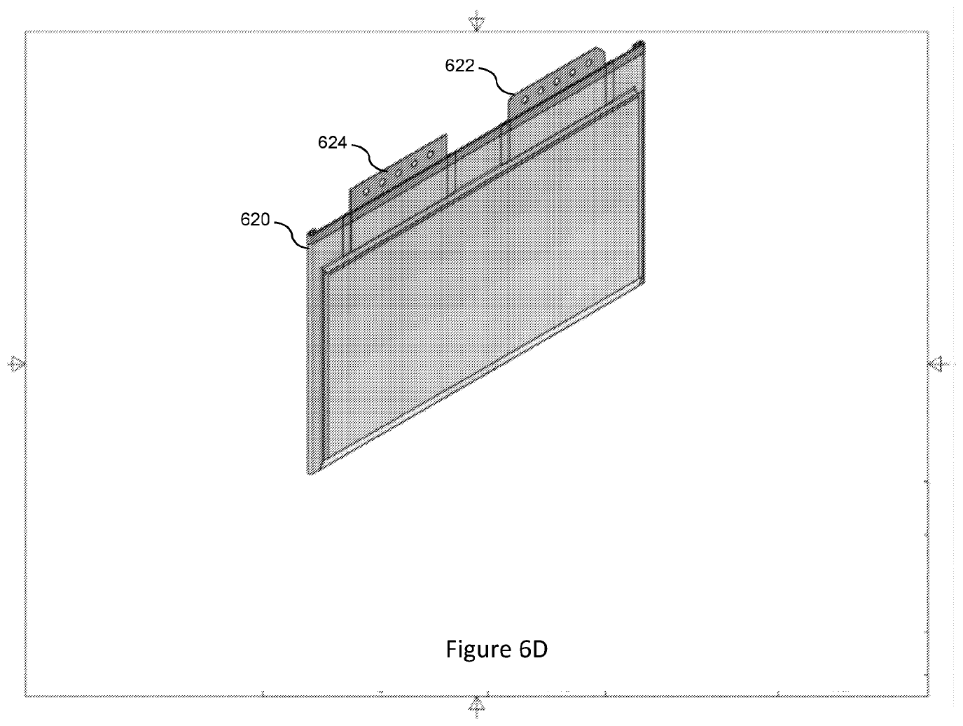

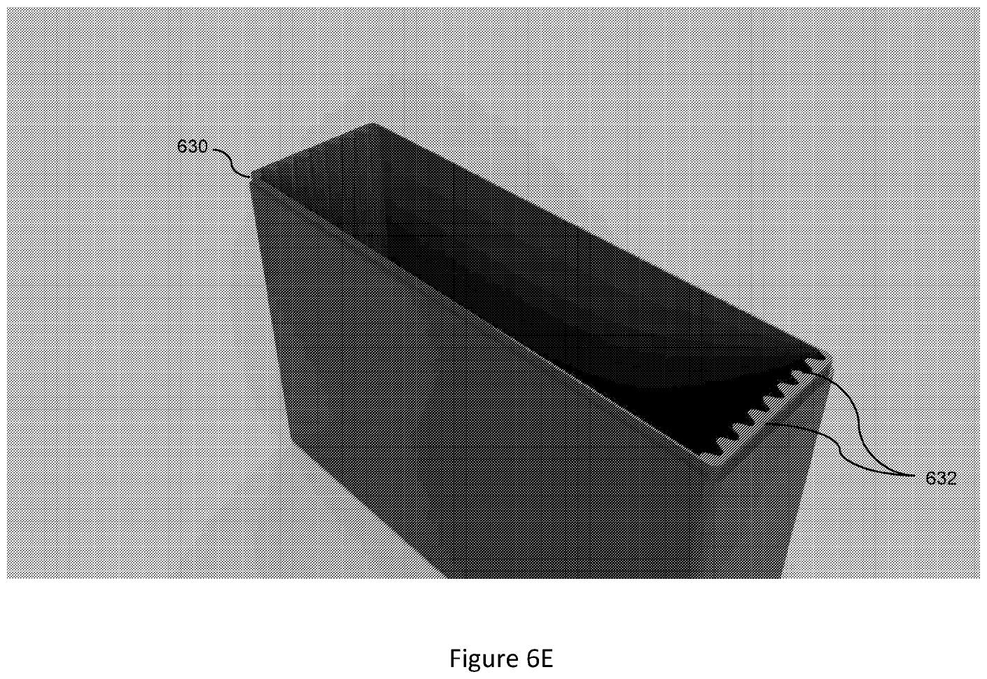

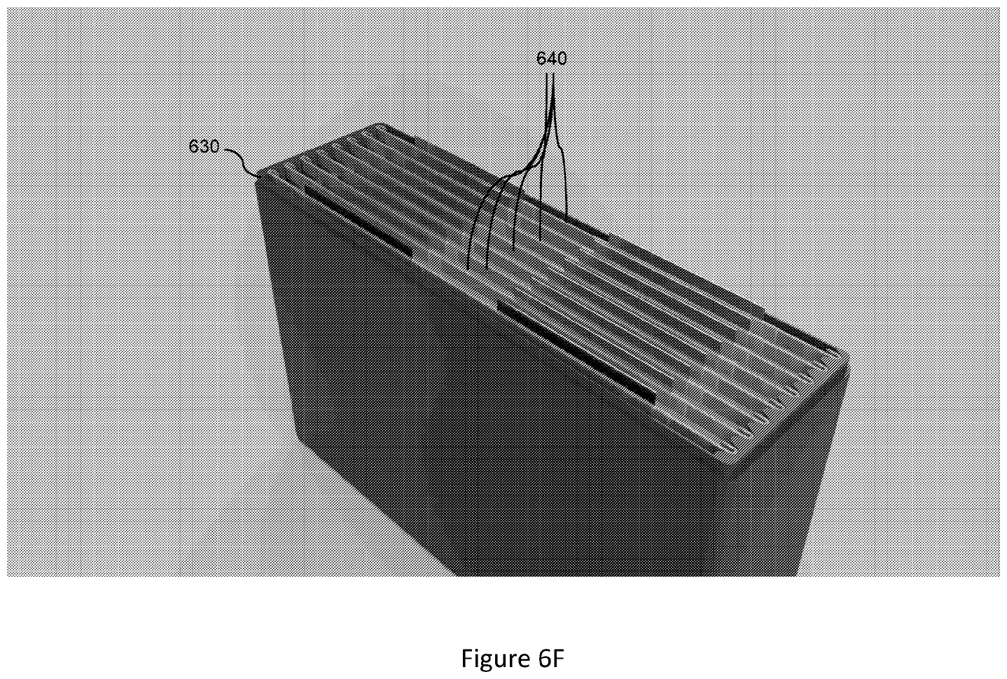

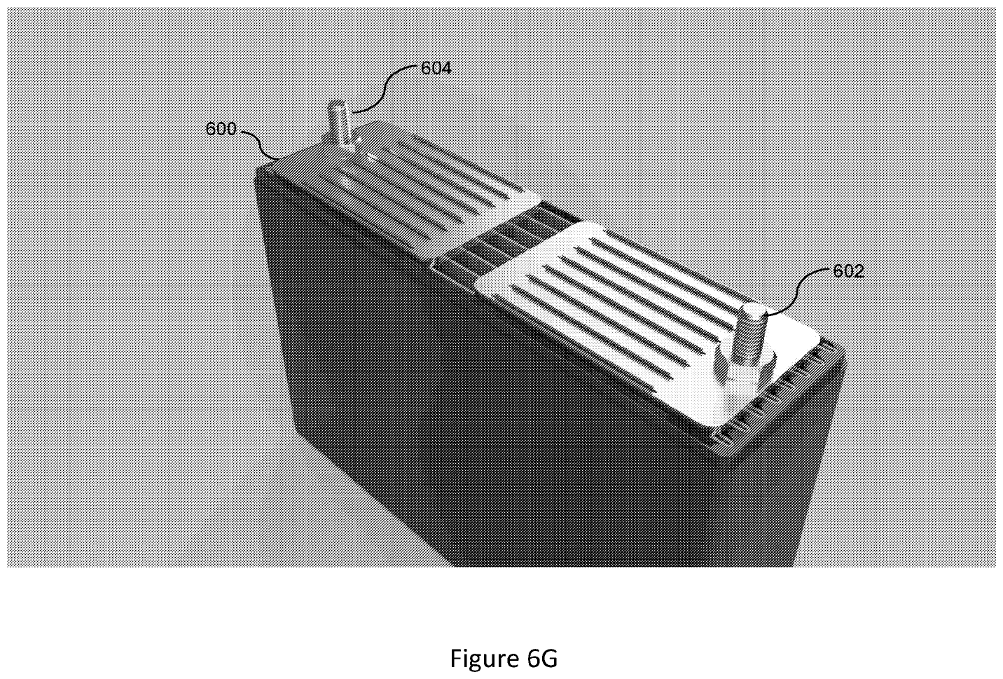

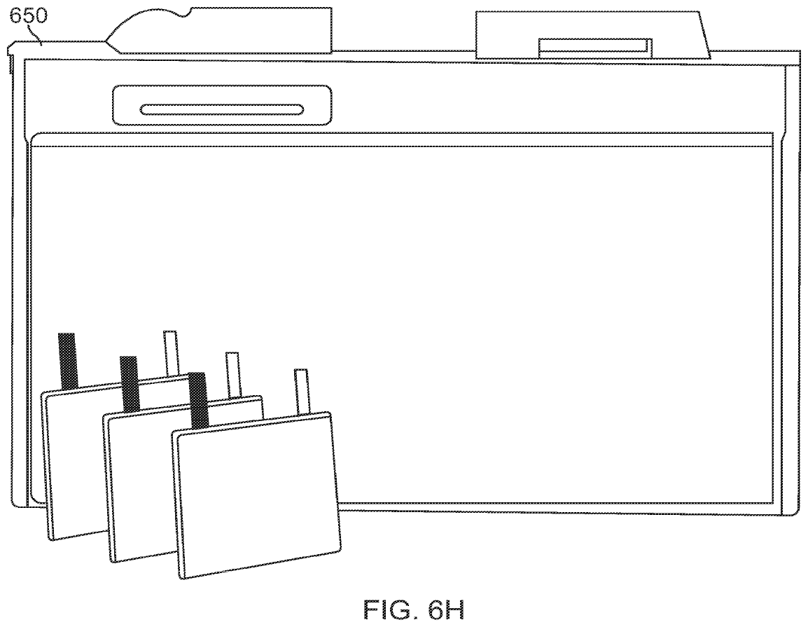

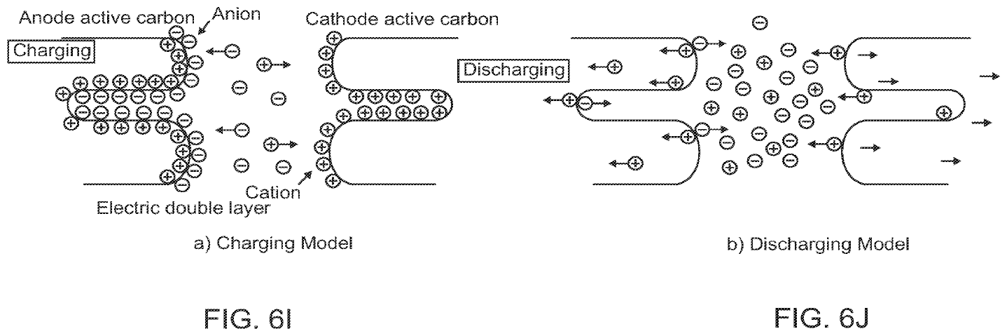

FIG. 6A illustrates an example graphene battery module 600 according to various embodiments of the disclosure. As shown, the graphene battery module 600 is fully enclosed, with only two terminals, a positive terminal 602 and a negative terminal 604, exposed in its casing.

The graphene battery module 600 (also referred to as a “power cell”) includes one or more supercapacitors. In some embodiments, the supercapacitors installed within the graphene battery module 600 are in a parallel arrangement. In one or more embodiments, the supercapacitors are configured in a series arrangement within the graphene battery module 600. In one or more embodiments, one or more supercapacitors are configured in a series arrangement and one or more supercapacitors are configured in a parallel arrangement within the graphene battery module 600.

Each supercapacitor may include two conductive plates (e.g., metal foils or metal coated polymer plates, etc.) for storing and releasing electrical charge and a separator (e.g., a microporous electrolytic paper). In one or more embodiments, the two conductive plates may be referred to as current collectors, that include for example, two metal plates (e.g., aluminum foils) for storing and releasing electrical charge and a separator. In various embodiments, a coating (e.g., carbon coating) is disposed on each of the metal or conductive plates to keep the positive and negative charges in place. In some embodiments, the coating includes carbon in the form of graphene. In some embodiments, the graphene portion of the coating may be between 1 and 100 weight percentage of the coating. In various embodiments, the coating may be produced using roller coating.

In various embodiments, the coating has a thickness between 1 micrometer and 100 micrometers, between 5 micrometers and 75 micrometers, between 10 micrometers and 50 micrometers, inclusive of any thickness ranges therebetween.

In one or more embodiments, the coating includes a porous material. In some embodiments, the porous nature of the carbon coating used in this electric double layer gives the metal plates a larger surface area which allows for a higher number of charges to be stored. The carbon coating used in the supercapacitor of the graphene battery module 600 (which acts as a supercapacitor) is much thinner than any dielectric used in a traditional capacitor, which means that the distance between the separated charges is much smaller. These two distinct features—the very small charge separation and the increased plate surface area—give the supercapacitor of the graphene battery module 600 a much higher energy density than that of traditional capacitors.

FIG. 6B illustrates an example supercapacitor 610 according to various embodiments of the disclosure. As shown, the supercapacitor 610 includes two metal plates 612 and 614, and a separator 616. A coating (e.g., carbon coating) may be disposed on each of the metal plates 612 and 614. For example, a positive electrode coating may be disposed onto the metal plate 612 and a negative electrode coating may be disposed onto the metal plate 614. The supercapacitor may also include a positive electrode connected to the metal plate 612 and a negative electrode connected to the metal plate 614, separated by the separator 616.

FIG. 6C illustrates a cross-sectional view of an example supercapacitor according to various embodiments of the disclosure. As shown in FIG. 6C, an electrolyte may be used to fill the porosities of the two electrodes and separator of the supercapacitor 610. The electrodes have foil extensions that are then welded to the terminals (e.g., the terminals 602 and 604 of the graphene battery module 600) to enable a current path to the outside of the capacitor. In some embodiments, one or more supercapacitors (each one similar to the supercapacitor 610) may be included in the graphene battery module 600. FIG. 6D is a perspective view of an example supercapacitor 620 according to various embodiments of the disclosure. As shown, the supercapacitor 620 includes foil extensions 622 and 624 that can be connected to the terminals (e.g., the terminals 602 and 604) of the graphene battery module 600. For example, when the supercapacitor 620 is disposed within the graphene battery module 600, the foil extension 622 may be connected to the positive terminal 602 and the foil extension 624 may be connected to the negative terminal 604 of the graphene battery module 600.

FIG. 6E is a perspective view of an enclosure 630 of the graphene battery module 600. As shown, the enclosure 630 has multiple slots (e.g., slots 632) on the two sides of the interior of the enclosure 630. The slots 630 are configured to enable supercapacitors to slide in place within the enclosure 630 of the graphene battery module 600. FIG. 6F illustrates multiple supercapacitors 640 (each similar to the supercapacitor 610) disposed within the enclosure 630 of the graphene battery module 600 by sliding through the slots 632.

FIG. 6G illustrates the terminals 602 and 604 of the graphene battery module 600 installed on the top side of the graphene battery module 600. As shown, the foil extensions of the supercapacitors 640 has been welded to the terminals 602 and 604 to provide contact to the terminals 602 and 604. FIG. 6H illustrates an example supercapacitor 650 that can be installed within a graphene battery module according to various embodiments of the disclosure. FIGS. 6I and 6J illustrate a charging model and a discharging model, respectively, for a supercapacitor according to various embodiments of the disclosure.

Below are some of the characteristics of the graphene battery modules constructed using the techniques disclosed herein:
High Energy Density
Quick Charge
100% Capacity Possible
Environmentally Responsible Option
Long Life Span—Outlives Most Devices
Solid State Battery—No Liquid
Long Lifespan
Can Be Used in Freezing Temperatures
Lower Fire Risk Than Lithium-Ion.
Does Not Produce Toxic Fumes While Charging

The table below is the Specification for an example graphene battery module:

| Specification | Value | Unit |
|---|---|---|
| Nominal Voltage | 4.00 | V |
| Max Surge Voltage | 4.25 | V |
| Max Continuous Voltage | 4.20 | V |
| Minimum Voltage | 3.80 | V |
| Nominal Current | 20.00 | A |
| Continuous Current | 40.00 | A |
| Peak Current | 60.00 | A |
| Capacitance | 21,000.00 | f |
| Charge Rating | 2 C | |
| Discharge Rating | 2 C | |
| Energy Storage | 75.00 | Wh |
| (Watt Hours) | | |
| Energy Storage | 18.75 | Ah |
| (Amp Hours) | | |
| Internal Resistance | ≤1.50 | mQ |
| Leakage Current | ≤0.278 | mA/h |
| Leakage Current Per Month | ≤0.200 | Ah |
| Leakage Rate Per Month | ≤1.067 | % |
| Cycle Life | 43,000 | |
| Operating Temp. Range | −20 to 60 | ° C. |
| Storage Temp. Range | −20 to 55 | ° C. |
| Protection Class | IP30 | |
| Product Weight | 350 | grams |
| Dimensions | 220 × 128 × 7.5 | mm |

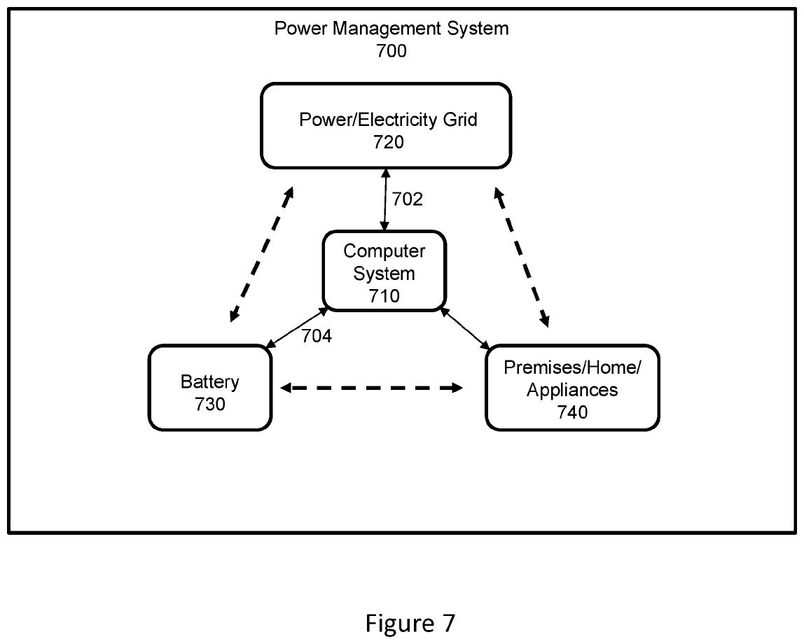

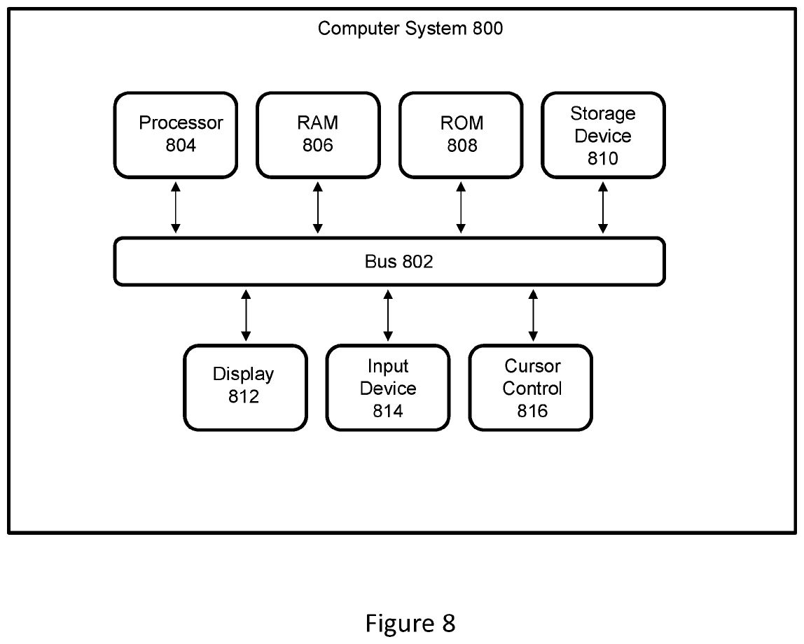

FIG. 7 illustrates an example power management system 700 that can be used to implement a battery pack to a power/electricity grid for supplying electricity according to an embodiment of the present disclosure. As illustrated in FIG. 7, the power management system 700 can include a computer system 710 that can be used to interface with a power/electricity grid 720 and a battery 730, such as the graphene battery pack as disclosed herein. In some embodiments, the power management system 700 includes a first interface 702 communicatively coupled to the electricity grid 720 associated with a premises 740 and a second interface 704 communicatively coupled to the battery 730, such as a graphene battery. In one or more embodiments, the computer system 700, such as computer system 800 as described below with respect to FIG. 8, includes one or more processors that can perform operations based on instructions stored in a (non-transitory) memory. In some embodiments, operations may include, for example but not limited to, providing power to appliances within the premises 740 under a first operation mode, wherein the first operation mode specifies the electricity grid as a sole power source for the appliances; detecting an abnormal event associated with the electricity grid associated with the premises; and in response to the detecting, configuring the power management system 700 to provide power to the appliances under a second operation mode, wherein the second operation mode specifies the battery 730 (e.g., graphene battery or graphene battery pack as disclosed herein) as the sole power source or a partial power source for the appliances.

### Computer Implemented System

FIG. 8 is a block diagram of a computer system 800, in accordance with various embodiments. Computer system 800 may be used as the computer system 710 in an example implementation for the power management system 700 as described above with respect to FIG. 7.

In one or more examples, computer system 800 can include a bus 802 or other communication mechanism for communicating information, and a processor 804 coupled with bus 802 for processing information. In various embodiments, computer system 800 can also include a memory, which can be a random-access memory (RAM) 806 or other dynamic storage device, coupled to bus 802 for determining instructions to be executed by processor 804. Memory also can be used for storing temporary variables or other intermediate information during execution of instructions to be executed by processor 804. In various embodiments, computer system 800 can further include a read only memory (ROM) 808 or other static storage device coupled to bus 802 for storing static information and instructions for processor 804. A storage device 810, such as a magnetic disk or optical disk, can be provided and coupled to bus 802 for storing information and instructions.

In various embodiments, computer system 800 can be coupled via bus 802 to a display 812, such as a cathode ray tube (CRT), liquid crystal display (LCD), or light emitting diode (LED) for displaying information to a computer user. An input device 814, including alphanumeric and other keys, can be coupled to bus 802 for communicating information and command selections to processor 804. Another type of user input device is a cursor control 816, such as a mouse, a joystick, a trackball, a gesture input device, a gaze-based input device, or cursor direction keys for communicating direction information and command selections to processor 804 and for controlling cursor movement on display 812. This input device 814 typically has two degrees of freedom in two axes, a first axis (e.g., x) and a second axis (e.g., y), that allows the device to specify positions in a plane. However, it should be understood that input devices 814 allowing for three-dimensional (e.g., x, y, and z) cursor movement are also contemplated herein.

Consistent with certain implementations of the present teachings, results can be provided by computer system 800 in response to processor 804 executing one or more sequences of one or more instructions contained in RAM 806. Such instructions can be read into RAM 806 from another computer-readable medium or computer-readable storage medium, such as storage device 810. Execution of the sequences of instructions contained in RAM 806 can cause processor 804 to perform the processes described herein. Alternatively, hard-wired circuitry can be used in place of or in combination with software instructions to implement the present teachings. Thus, implementations of the present teachings are not limited to any specific combination of hardware circuitry and software.

The term “computer-readable medium” (e.g., data store, data storage, storage device, data storage device, etc.) or “computer-readable storage medium” as used herein refers to any media that participates in providing instructions to processor 804 for execution. Such a medium can take many forms, including but not limited to, non-volatile media, volatile media, and transmission media. Examples of non-volatile media can include, but are not limited to, optical, solid state, magnetic disks, such as storage device 810. Examples of volatile media can include, but are not limited to, dynamic memory, such as RAM 806. Examples of transmission media can include, but are not limited to, coaxial cables, copper wire, and fiber optics, including the wires that comprise bus 802.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, PROM, and EPROM, a FLASH-EPROM, any other memory chip or cartridge, or any other tangible medium from which a computer can read.

In addition to computer readable medium, instructions or data can be provided as signals on transmission media included in a communications apparatus or system to provide sequences of one or more instructions to processor 804 of computer system 800 for execution. For example, a communication apparatus may include a transceiver having signals indicative of instructions and data. The instructions and data are configured to cause one or more processors to implement the functions outlined in the disclosure herein. Representative examples of data communications transmission connections can include, but are not limited to, telephone modem connections, wide area networks (WAN), local area networks (LAN), infrared data connections, NFC connections, optical communications connections, etc.

It should be appreciated that the methodologies described herein, flow charts, diagrams, and accompanying disclosure can be implemented using computer system 800 as a standalone device or on a distributed network of shared computer processing resources such as a cloud computing network.

The methodologies described herein may be implemented by various means depending upon the application. For example, these methodologies may be implemented in hardware, firmware, software, or any combination thereof. For a hardware implementation, the processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

In various embodiments, the methods of the present teachings may be implemented as firmware and/or a software program and applications written in conventional programming languages such as C, C++, Python, etc. If implemented as firmware and/or software, the embodiments described herein can be implemented on a non-transitory computer-readable medium in which a program is stored for causing a computer to perform the methods described above. It should be understood that the various engines described herein can be provided on a computer system, such as computer system 800, whereby processor 804 would execute the analyses and determinations provided by these engines, subject to instructions provided by any one of, or a combination of, the memory components RAM 806, ROM, 808, or storage device 810 and user input provided via input device 814.

1. A battery, comprising:
a positive terminal;
a negative terminal; and
one or more supercapacitors each connected to the positive terminal and the negative terminal,
wherein each of the one or more supercapacitors comprises a positive current collector (metal plate) having a first graphene coating, a negative current collector (metal plate) having a second graphene coating, and a separator disposed between the first graphene coating and the second graphene coating.

2. The battery of claim 1, wherein the one or more supercapacitors are configured in a parallel arrangement.

3. The battery of claim 2, wherein a subset of the one or more supercapacitors are configured in a series arrangement.

4. The battery of claim 1, wherein the first graphene coating and the second graphene coating each comprises a coating having a thickness between 1 micrometer and 100 micrometers.

5. The battery of claim 1, wherein the first graphene coating and the second graphene coating each comprises a porous graphene coating.

6. The battery of claim 1, wherein the separator comprises a microporous electrolytic paper.

7. The battery of claim 1, wherein the positive current collector (metal plate) of each of the one or more supercapacitors is electrically connected to the positive terminal and the negative current collector (metal plate) of each of the one or more supercapacitors is electrically connected to the negative terminal.

8. A power management system, comprising:
a first interface communicatively coupled to an electricity grid associated with a premises;
a second interface communicatively coupled to a graphene battery;
one or more hardware processors; and
a non-transitory memory storing instructions that when executed by the one or more hardware processors cause the one or more hardware processors to perform operations comprising:
providing power to appliances within the premises under a first operation mode, wherein the first operation mode specifies the electricity grid as a sole power source for the appliances;
detecting an abnormal event associated with the electricity grid associated with the premises; and
in response to the detecting, configuring the power management system to provide power to the appliances under a second operation mode, wherein the second operation mode specifies the graphene battery as the sole power source or a partial power source for the appliances.

9. The power management system of claim 8, wherein the graphene battery comprises one or more supercapacitors configured in a parallel arrangement.

10. The power management system of claim 8, wherein the graphene battery comprises one or more supercapacitors configured in a series arrangement.

11. The power management system of claim 9, wherein each of the one or more supercapacitors comprises a first graphene coating disposed on a positive current collector and a second graphene coating disposed on a negative current collector.

12. The power management system of claim 11, wherein each of the first and second graphene coatings has a thickness between 1 micrometer and 100 micrometers.

13. The power management system of claim 11, wherein the first and second graphene coatings are porous.

14. The power management system of claim 9, wherein each of the one or more supercapacitors comprises a positive current collector (metal plate), a negative current collector (metal plate), and a microporous electrolytic paper disposed therebetween.

15. A battery module, comprising:
an enclosure;
a positive terminal and a negative terminal; and
one or more supercapacitors disposed within the enclosure,
wherein each one of the one or more supercapacitors are connected to the positive terminal and the negative terminal,
wherein each one of the one or more supercapacitors comprises a positive metal plate, a negative metal plate, and a separator,
wherein a first carbon coating is disposed on a surface of the positive metal plate, and
wherein a second carbon coating is disposed on a surface of the negative metal plate.

16. The battery module of claim 15, wherein a subset of the one or more supercapacitors are configured in a parallel arrangement.

17. The battery module of claim 16, wherein a subset of the one or more supercapacitors are configured in a series arrangement.

18. The battery module of claim 15, wherein the first carbon coating and the second carbon coating each comprises graphene.

19. The battery module of claim 15, wherein the first carbon coating and the second carbon coating each has a thickness between 1 micrometer and 100 micrometers.

20. The battery module of claim 15, wherein the first carbon coating and the second carbon coating are porous.
